(19) United States
(12) Patent Application Publication
(10) Pub. No.: US 2022/0353957 A1
(43) Pub. Date: Nov. 3, 2022

(54) POSITIVE TEMPERATURE COEFFICIENT HEATING OF LABORATORY DIAGNOSTIC INSTRUMENTS

(71) Applicant: Siemens Healthcare Diagnostics Inc., Tarrytown, NY (US)

(72) Inventor: Christopher P. Ebeling, Newfoundland, NJ (US)

(73) Assignee: Siemens Healthcare Diagnostics Inc., Tarrytown, NY (US)

(21) Appl. No.: 17/279,071

(22) PCT Filed: Sep. 26, 2019
(86) PCT No.: PCT/US2019/053299

§ 371 Date: Mar. 23, 2021

Related U.S. Application Data
(60) Provisional application No. 62/738,083, filed on Sep. 28, 2018.

(51) Int. Cl. H05B 3/50; H05B 3/06; G01N 35/10

(52) U.S. Cl. CPC H05B 3/50; H05B 3/06; G01N 35/10; G01N 2035/00356

(57) ABSTRACT

A diagnostic device has a sample probe for receiving sample material from one or more containers, a sample line for delivering the sample material to one or more reaction containers, a reagent supply and reagent supply line for supplying reagent to the one or more reaction containers, an incubation ring for receiving the reaction containers and incubating a mixture of the sample material and the reagent for a period of time, and a heating system for heating one or more areas or components of the device. The heating system has one or more positive temperature coefficient heaters.

### RELATED APPLICATION

This application claims priority to U.S. Provisional Patent Application No. 62/738,083, filed Sep. 28, 2018 and titled “POSITIVE TEMPERATURE COEFFICIENT HEATING OF LABORATORY DIAGNOSTIC INSTRUMENTS,” which is hereby incorporated by reference in its entirety herein for all purposes.

### TECHNICAL FIELD

The present application relates generally to temperature control of laboratory diagnostic instruments and, more particularly, to positive temperature coefficient heating of fluidic vessels, sub-systems, tubing and other components in an assay handling system.

### BACKGROUND

Temperature-sensitive assays require the precise thermal management of all the fluidic vessels, sub-systems and tubing that interact with them during diagnostic testing. To house all of the mechanical and mechatronic assemblies, the assay handling systems and other laboratory diagnostic instruments are often large and have several doors and openings through which cold air can seep. The environment where the diagnostic tests are carried out must be independent of the ambient air surrounding the instrument. In other words, the temperature of the laboratory where the operator works cannot impact the internal temperature of the instrument, regardless of temperature variance in the laboratory. Thermal management of the instruments' internal environment may be challenging, often requiring large convective heaters and complex control loops.

For example, in a conventional assay handling system, powerful forced hot-air convection heaters are placed within the instrument, to heat the entire air volume where precise diagnostic tests are carried out. They must be carefully placed to guarantee temperature uniformity across all key subsystems. FIG. 1 illustrates a typical instrument 100 (e.g., assay handling system) in which convection heaters are used to heat the air volume where temperature-sensitive handling and testing is performed. The instrument 100 includes an internal air volume 110 and a movable door 120. The internal air volume 110 may be required to be within a particular temperature range during operation of the instrument 100. Movement of the door 120 may expose the internal air volume 110 to an ambient temperature. Therefore, a heating element may be needed to heat the internal air volume 110 to a desired temperature after the door 120 is closed. FIG. 2 illustrates exemplary placement of convection heaters 200 used to heat the air volume 110 within the instrument 100. FIG. 3 illustrates an example of a typical forced hot-air convection heater 300 that may be used in conjunction with the instrument 100.

The heated flow of air from the convection heater circulates through the assay handling system to regulate the temperature in and around certain areas. Multiple convection heaters may be placed at different locations around the instrument and may be separately controllable to further control temperature at different locations within the instrument. A control loop feedback system (e.g., temperature sensor) is used to control the convection heaters. For example, when a temperature threshold is sensed, a temperature sensor may send a signal to turn on or off a convection heater in order to adjust the temperature to within a desired range.

In the case of an assay handling system, the sub-systems that are housed within the air volume of the overall housing depend on heated flow from a convection heater. Any disturbance to the environment results in downtime to allow the system to recover to the optimal thermal environment for testing. For example, when an operator opens the cover doors to reload cuvettes or fix a jam, the thermal environment is disturbed and downtime is necessary to allow the convention heater(s) to return the internal air volume temperature to the desired range.

The present disclosure describes an alternative heating solution for laboratory diagnostic instruments, such as assay handling systems, that does not rely on large convection heaters or complex feedback control.

### SUMMARY

In some embodiments, a diagnostic device includes a sample probe for receiving sample material from one or more containers, a sample line for delivering the sample material to one or more reaction containers, a reagent supply and reagent supply line for supplying reagent to the one or more reaction containers, an incubation ring for receiving the reaction containers and incubating a mixture of the sample material and the reagent for a period of time, and a heating system for heating one or more areas or components of the device. The heating system includes one or more PTC heaters.

In some embodiments, a diagnostic device includes one or more assay handling components and a heating system configured to heat the one or more assay handling components. The heating system includes one or more PTC heaters. The one or more PTC heaters comprise a substrate and a PTC material. The PTC material is connected to a current supply and is selected to heat on a self-regulating basis to a threshold temperature. The threshold temperature is selected based on a desired temperature range for the one or more assay handling components.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 depicts an exemplary laboratory diagnostic device that may be used in conjunction with disclosed embodiments of a heating system;

FIG. 2 depicts an exemplary laboratory diagnostic device having one or more heating elements according to conventional methods;

FIG. 3 depicts an exemplary embodiment of a conventional forced-air heating device;

FIG. 4 is a schematic diagram of an exemplary laboratory diagnostic device having a heating system, consistent with disclosed embodiments;

FIG. 5 is a first view of an exemplary sample probe that may be used in conjunction with disclosed embodiments of a heating system;

FIG. 6 is a second view of the exemplary sample probe that may be used in conjunction with disclosed embodiments of a heating system; and

FIG. 7 is an exploded view of an incubation ring that may be used in conjunction with disclosed embodiments of a heating system.

### DETAILED DESCRIPTION OF EXEMPLARY EMBODIMENTS

The present disclosure describes a heating device for a laboratory diagnostic instrument, such as an assay handling system. The heating device uses a positive temperature coefficient (PTC) material as a heating element. A PTC material is a material that exhibits a positive resistance change in response to a temperature increase. A heater that utilizes a PTC material (referred to herein as a “PTC heater”) is a self-regulating device that does not rely on external feedback control to maintain a particular temperature (the “threshold temperature”). Disclosed embodiments include particular implementations of heating devices that include PTC heaters for temperature regulation within a laboratory diagnostic instrument.

The PTC heater draws current through a printed circuit, thereby increasing the temperature of the PTC material and giving off heat. As the temperature of the PTC material increases, the temperature of the overall PTC heater also increases, thereby restricting the current flow and abating heat generation. The PTC heater is designed such that a temperature and resistance equilibrium is reached at the desired threshold temperature. In other words, when the PTC heater is below the threshold temperature, resistance is lower and current is higher, producing more heat. When the PTC heater reaches the threshold temperature, the resistance of the PTC material has increased such that any heat generation does not further increase the temperature of the PTC heater.

In some embodiments, a heating system may include a PTC heater in place of a conventional forced-air convection heater used currently. The PTC heater may be placed in a position to heat the air volume within the instrument and allow the air volume to control the temperature of the nearby components and sub-assembly. In other embodiments, a disclosed heating device may include a PTC heater in place to perform conduction heating of one or more nearby elements of the instrument. The PTC heater does not require a control loop (e.g., temperature sensor, external controls, etc.); the PTC material is self-regulating by way of the relationship between temperature and resistance.

A heating system having a PTC heater according to disclosed embodiments may be formed in a variety of sizes, shapes, and configurations, according to a particular set of desired characteristics, placement within the overall instrument, and/or associated components for heating. For example, a PTC heater can be formed from a highly flexible substrate such that the device can be wrapped around tubing. In another example, the PTC heater can be interposed within a sub-assembly, such as an incubation ring, to locally heat the sub-assembly when needed.

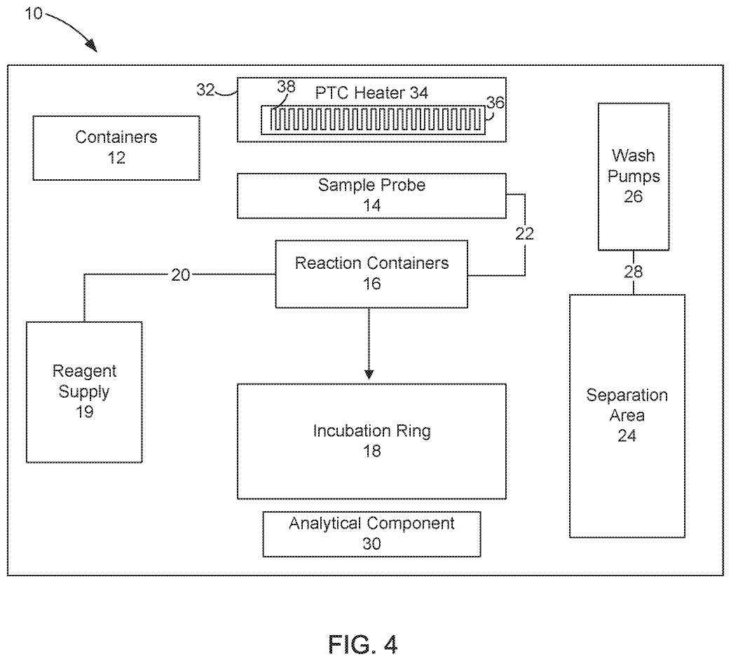

FIG. 4 is a schematic diagram of an exemplary laboratory diagnostic device 10, such as an automated clinical chemistry analyzer. The diagnostic device 10 receives a plurality of fluid containers 12, such as tubes or vials containing patient samples to be analyzed. The diagnostic device 10 includes a plurality of assay handling components, as shown in FIG. 4. The diagnostic device 10 extracts a liquid sample with a sample probe 14 from the fluid container 12 and combines the sample with various reagents in specialized reaction containers 16. The diagnostic device 10 may further include an incubation ring 18 for fluid containers 12 and/or reaction containers 16 for a period of time to incubate a mixture of a sample and a reagent. The diagnostic device 10 also includes a reagent supply reservoir 19 and a plurality of liquid transport lines or tubing, including a reagent supply line 20 and a sample line 22. The reagent supply line 20 provides reagent from the reagent supply reservoir 19 to the reaction containers 16. The sample line 22, which is connected to the sample probe 14, delivers sample material from the fluid containers 12 to the reaction containers 16. The diagnostic device 10 may also include one or more wash components for cleaning and washing the various components of the diagnostic device 10. The wash components may include, for example, a wash separation area 24, one or more wash pumps 26, and wash fluid lines 28 that supply a washing fluid. The diagnostic device 10 further includes one or more analytical components 30 configured to analyze the mixed sample and reagent to identify one or more measurements and/or criteria. The diagnostic device 10 also includes a heating system 32 configured to maintain one or more areas or components of the diagnostic device 10 at a desired temperature or temperature range. It should be understood that the described components of the laboratory diagnostic device 10 are exemplary and that additional or alternative components and sub-assemblies may be included.

In an exemplary use of the diagnostic device 10, a tray of containers 12 containing patient samples is loaded into the diagnostic device 10. The sample probe 14 draws a portion of each sample and delivers it to a reaction container 16, to be mixed with a reagent. The mixed solution is stored in the incubation ring 18 for a period of time to allow the reaction to occur. The reaction containers 16 are then analyzed by the analytical components 30. The remaining sample and/or reagent mixtures are purged form the system and the washing components deliver a cleaning fluid to clean the various components for the next sample analysis run.

In many diagnostic devices, temperature control of various areas and/or components within the device is needed in order to successfully carry out a diagnostic test. For example, the samples, reagents, and mixtures of the two often must be kept within a particular temperature range in order to accurately analyze the mixture and measure results. The heating system 32 is configured to heat one or more areas within the diagnostic device 10 in order to help maintain that temperature and/or restore the temperature after it has dropped. In an exemplary embodiment, the heating system 32 includes at least one PTC heater 34. The PTC heater 34 may be arranged in a variety of locations and configurations in order to provide localized and/or ambient heating to one or more components of the diagnostic device 10. The PTC heater 34 may be connected to one or more power supplies, such as a power supply associated with the diagnostic device 10 or a separate power supply.

The PTC heater 34 preferably includes a substrate 36 and a PTC material 38. The PTC material 38 may be in the form of an ink that is printed onto the substrate 36 in a pattern (e.g., size, shape, arrangement of the printed circuit on the substrate 36). The PTC material 38 and the pattern may be selected such that the PTC heater 34 is designed with a threshold temperature that the PTC heater 34 self-regulates itself to maintain. For instance, the PTC material 38 may be tuned to deliver high resistance when the desired threshold temperature is reached. In one example, if the PTC heater 34 is designed to hold 33° C., the resistance of the PTC material 38 increases to the point where the PTC heater 34 effectively shuts down at 33° C. If the surrounding temperature is less than 33° C., the resistance drops and current flows into the heater until 33° C. is stabilized.

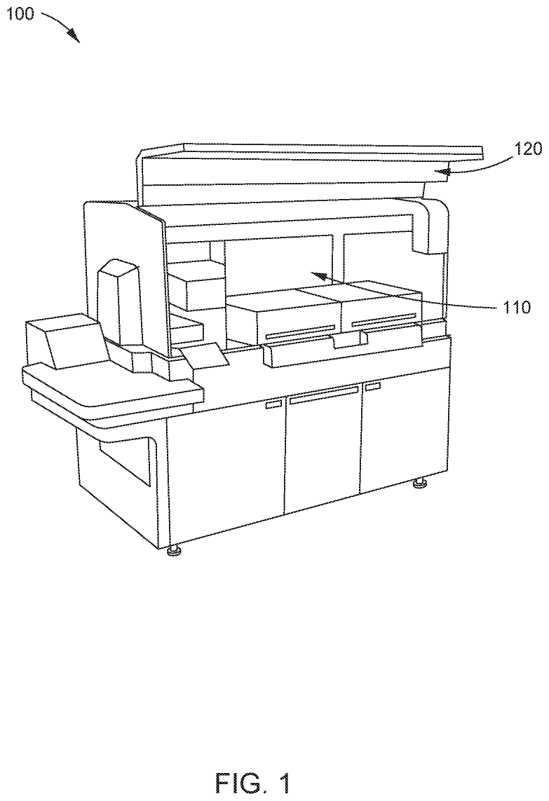

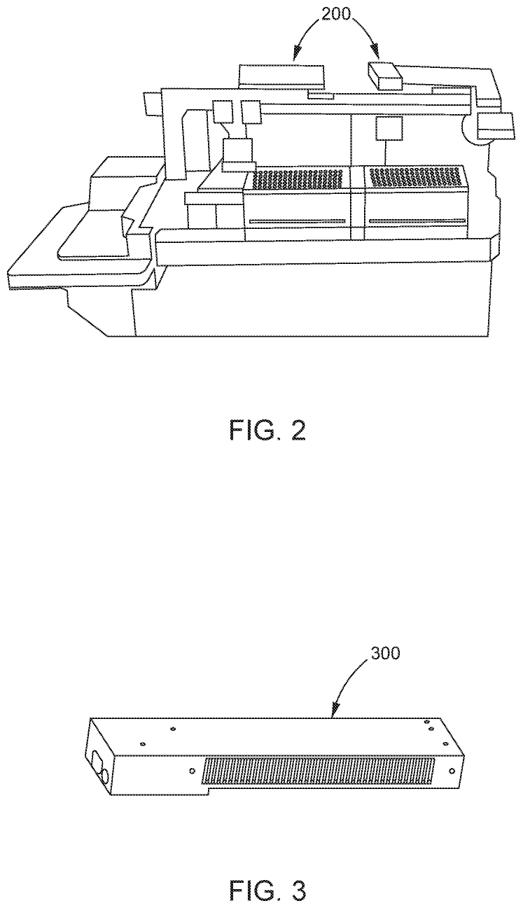

In an exemplary embodiment, the PTC heater 34 may be implemented for heating of the air volume within the diagnostic device 10. In conventional systems, a forced air heater is placed in a position to provide a hot air stream through the device to heat components and sub-assemblies through convection (e.g., FIG. 2). In an exemplary embodiment, a PTC heater 34 may be used for convective heating. The PTC heater 34 may be positioned to heat an air volume within the diagnostic device 10. For example, the PTC heater 34 may be positioned adjacent to the air volume 110 shown in FIG. 1. In this embodiment, the PTC heater 34 performs global heating. The PTC heater 34 cannot overheat and therefore does not require a feedback control loop to control operation of the heater. A PTC heater 34 is more cost effective than current heating elements that are used for convective heating of diagnostic instruments.

In other embodiments, the PTC heater 34 may be configured to heat one or more lines of tubing within the diagnostic device 10. These lines of tubing may include, for example, one or more of the reagent supply line 20, the sample line 22, or the wash fluid lines 28. In one example, the PTC heater 34 is used to heat reagent in the reagent supply line 20.

The PTC heater 34 may be implemented to heat the reagent in a variety of manners. In one example, the reagent supply line 20 may be wrapped in a PTC heater 34 that is formed of a flexible material. For example, the substrate 36 may be flexible such that it can be formed in a tube-shape to surround at least a portion of the tubing that forms the reagent supply line 20. In another example, the PTC heater 34 may form a part of a multi-lumen tube that forms the reagent supply line 20. For example, the reagent supply line 20 may be made up of multiple layers of tubing, at least one of the layers being the PTC heater 34. In some instances, the reagent supply line 20 may be connected to a conductive heat pipe. The PTC heater 34 may conductively heat the pipe for heating the reagent in the supply line 20. In another example, the PTC heater 34 may conductively heat the reagent supply reservoir 19. For example, the PTC heater 34 may be attached to or wrapped around the reagent supply reservoir 19 in order to maintain the supply of reagent at a threshold temperature.

In some embodiments, the reagent supply line 20 may include a heat exchanger that is heated by the PTC heater 34. For example, the PTC heater 34 may be embedded in the reagent supply line 20 by printing the PTC material 38 onto the tubing of the reagent supply line 20. In another example, the PTC heater 34 may be attached alongside the reagent supply line 20 in a configuration for conductive and/or convective heating of the reagent.

In other embodiments, a chain or guide that is used in conjunction with the reagent supply line 20 may be heated by the PTC heater 34. Further, any portion of a reagent probe or reagent probe assembly may be heated with a PTC heater 34.

In another exemplary embodiment, a PTC heater 34 may be used for local heating of the sample probe 14. The sample probe 14 may be outfitted with one or more PTC heaters 34 on or around the sample probe 14 to quickly heat to and maintain a desired temperature of the sample probe 14 and any adjacent or nearby sample probe components.

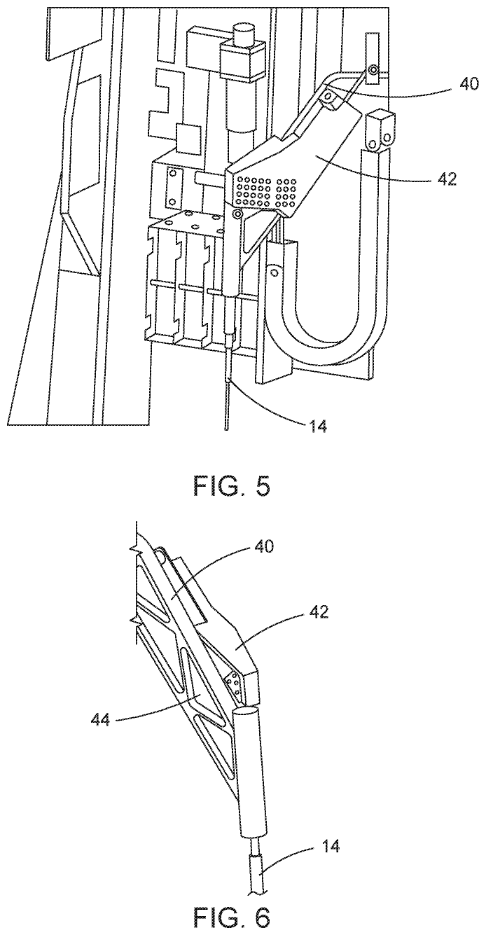

FIGS. 5 and 6 are illustrations of an exemplary sample probe 14. The sample probe 14 includes a movable control arm 40 and a cover 42. The control arm 40 may include a plurality of webs 44 that make up the control arm 40. In some embodiments, the PTC heater 34 may be connected to the control arm 40 and/or cover 42 of the sample probe 14 in order to provide localized heating around the sample probe 14. In some embodiments, the PTC heater 34 may be attached to the cover 42 or placed within the webs 44. In other embodiments, the PTC heater 34 may be embedded into the cover 42 and/or the webs 44. In some embodiments, the PTC material 38 may be printed directly onto the cover 42 and/or webs 44.

In some embodiments, a PTC heater 34 may be positioned and configured to heat the sample line 22. For example, any of the embodiments described with respect to the reagent supply line 20 may be applied to the sample line 22 (and/or the wash fluid lines 28). For instance, the sample line 22 could be formed as a multi-lumen tube having the PTC heater 34 therein, the PTC heater 34 may be connected to a conductive heat pipe connected to the sample line 22, a heat exchanger associated with the sample line 22 may include the PTC heater 34 (e.g., the PTC material 38 may be printed onto the tubing of the sample line 22), and/or a chain or guide associated with the sample line 22 may be heated with a PTC heater 34.

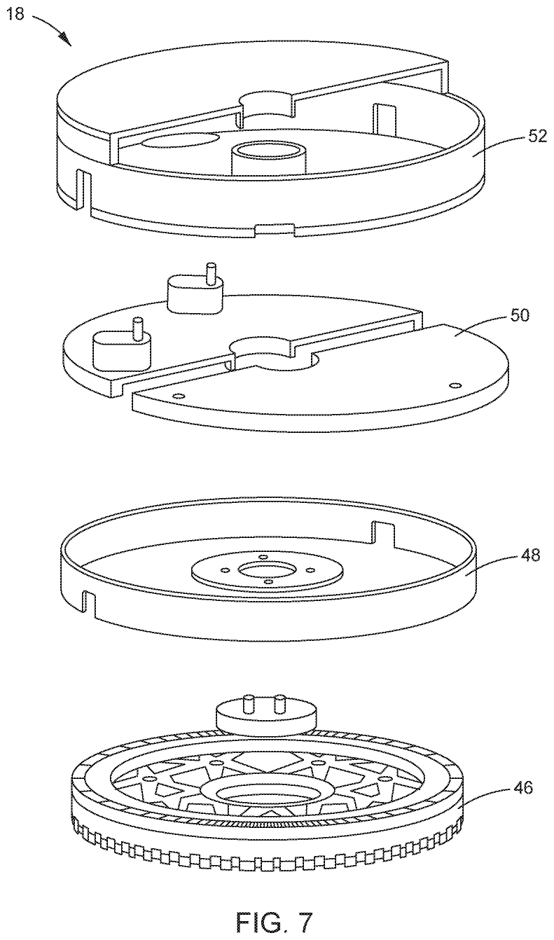

In another embodiment, a PTC heater may be used for local heating of the incubation ring 18. FIG. 7 is an illustration of an exemplary incubation ring 18 in an exploded view. The incubation ring 18 includes a ring 46, a heating element 48, a cover 50, and an insulating housing 52. The ring 46 may include a molded plastic portion and cast metal portion (e.g., aluminum). The ring 46 receives the reaction containers 16 and the cover 50 and insulating housing 52 enclose the reaction containers 16 at least partially to incubate the mixture within the reaction containers 16 for a period of time. The heating element 48 is positioned adjacent to the ring 46 in order to provide heat to maintain a temperature within the incubation ring 18 before, during, and/or after an incubation period.

In one embodiment, the heating element 48 is formed as a ring (as shown in the exemplary illustration of FIG. 7). The ring-shaped heating element 48 may be a PTC heater 34. For example, the substrate 36 may be flexible to wrap around the ring 46. In another embodiment, the substrate 36 may be the cast metal portion of the ring 46, with the PTC material 38 being printed directly onto the ring 46. In other embodiments, a PTC heater 34 may be positioned for convection heating of the incubation ring 46.

An exemplary laboratory diagnostic device 10 may include one or more of the heating system 32 embodiments described herein. For example, a convection PTC heater may be positioned to heat a volume of air within the diagnostic device 10 in combination with one or more local PTC heaters positioned for conductive heating of one or more of the sample probe 14, incubation ring 18, reagent supply line 20, sample line 22, wash separation area 24, wash pumps 26, or wash fluid lines 28. While certain components have been described for localized heating with a PTC heater 34, it should be understood that other components of the diagnostic device 10 and/or other devices may include PTC heaters connected or integrated for conductive and/or convective heating to a desired temperature. In an alternative embodiment, a PTC heater 34 may be used as a temperature sensor with a conventional heating system (e.g., forced-air over conventional heating element).

The disclosed embodiments describe laboratory diagnostic instruments and related components that utilize PTC heating in order to achieve or maintain a desired temperature. The self-regulating nature of a PTC heater is well-suited for the various components of diagnostic equipment. This is due in part to the small size and adaptable shape of PTC heaters. Further, PTC heaters do not overheat and therefore do not require external controls or feedback mechanisms that add complexity and cost to the system.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f) unless the element is expressly recited using the phrase “means for.”.

What is claimed is:

1. A diagnostic device, comprising:
a sample probe for receiving sample material from one or more containers;
a sample line for delivering the sample material to one or more reaction containers;
a reagent supply and reagent supply line for supplying reagent to the one or more reaction containers;
an incubation ring for receiving the reaction containers and incubating a mixture of the sample material and the reagent for a period of time; and
a heating system for heating one or more areas of the diagnostic device, the heating system comprising one or more PTC heaters.

2. The diagnostic device of claim 1, wherein the PTC heater is a convective heater configured to heat a volume of air within the diagnostic device.

3. The diagnostic device of claim 1, wherein the PTC heater is a conductive heater configured to heat a component in contact with the PTC heater.

4. The diagnostic device of claim 3, wherein the component is one or more of the sample probe, the sample line, the reagent supply, the reagent supply line, or the incubation ring.

5. The diagnostic device of claim 1, wherein the PTC heater comprises a substrate and a PTC material.

6. The diagnostic device of claim 5, wherein the substrate is tubing that forms the sample line or the reagent supply line, and the PTC material is formed on the tubing.

7. The diagnostic device of claim 5, wherein the substrate is a flexible material and the PTC heater is wrapped around tubing that forms the sample line or the reagent supply line.

8. The diagnostic device of claim 1, wherein the sample probe includes a control arm and a cover and the PTC heater is attached to one or more of the control arm and the cover.

9. The diagnostic device of claim 8, wherein the control arm includes a plurality of webs and the PTC heater is connected within or embedded into one or more of the plurality of webs.

10. The diagnostic device of claim 1, wherein the PTC heater is positioned within the incubation ring.

11. The diagnostic device of claim 10, wherein the incubation ring includes the PTC heater wrapped around a ring that receives the reaction containers.

12. The diagnostic device of claim 10, wherein the incubation ring includes a ring that receives the reaction containers, the ring comprising a metal component, and
metal component is a substrate for the PTC heater and a PTC material of the PTC heater is formed on the metal component.

13. A diagnostic device comprising:
one or more assay handling components; and
a heating system comprising one or more PTC heaters configured to heat the one or more assay handling components,
wherein:
the one or more PTC heaters comprise a substrate and a PTC material,
the PTC material is connected to a current supply and is selected to heat on a self-regulating basis to a threshold temperature, and
the threshold temperature is selected based on a desired temperature range for the one or more assay handling components.

14. The diagnostic device of claim 13, wherein the one or more assay handling components include tubing for a reagent supply line or a sample line.

15. The diagnostic device of claim 14, wherein the substrate is wrapped around the tubing.

16. The diagnostic device of claim 14, wherein the tubing is the substrate of the PTC heater.

17. The diagnostic device of claim 14, wherein the tubing is a multi-lumen structure, with one of the lumen layers being the substrate.

18. The diagnostic device of claim 13, wherein the one or more assay handling components include an incubation ring, the incubation ring comprising a ring for receiving one or more reaction containers.

19. The diagnostic device of claim 18, wherein the substrate is wrapped around the ring.

20. The diagnostic device of claim 18, wherein the ring comprises a metal component, the metal component being the substrate of the PTC heater.
